(19) United States
(12) Patent Application Publication
(10) Pub. No.: US 2015/0124434 A1
(43) Pub. Date: May 7, 2015

(54) DIRECT TYPE BACKLIGHT MODULE

(71) Applicant: HON HAI PRECISION INDUSTRY CO., LTD., New Taipei (TW)

(72) Inventor: SHAO-HAN CHANG, New Taipei (TW)

(21) Appl. No.: 14/496,434

(22) Filed: Sep. 25, 2014

(30) Foreign Application Priority Data
Nov. 6, 2013 (CN) 2013105438978

(51) Int. Cl. G02F 1/1335

(52) U.S. Cl. CPC G02F 1/133605; G02F 1/133603; G02F 1/133608; G02F 1/133611
USPC 362/97.3

(57) ABSTRACT

A backlight module includes an optical film, a light source panel, a number of light sources mounted on the light source panel, and a reflective frame positioned between the optical film and the light source panel. The reflective frame includes an upper frame, a lower frame, and a reflective plate positioned between the upper frame and the lower frame. The upper frame includes a receiving portion for receiving the optical film, the lower frame is connected with the light source panel, and the reflective plate defines a number of through holes. The reflective plate, the lower frame, and the light source panel cooperatively define a closed chamber.

### FIELD

This disclosure relates to backlight modules, and particularly, to a direct type backlight module.

### BACKGROUND

Along with the progress of modern video technology, a liquid crystal display apparatus (LCD) has been applied in cell phones, laptops, personal computers (PC), personal digital assistants (PDA), and other consumer electronic products. Since the LCD panel of an LCD apparatus itself does not have the function of emitting light, a backlight module is needed to be disposed under the LCD panel to provide the LCD panel with a required light source so as to make the LCD panel display.

The known backlight module can be divided into a direct-light type and an edge-light type according to the location of the light source. A conventional direct-light type backlight module includes a bezel, a frame, a light source, a light guide plate, a diffusion plate, and a number of optical films. The optical films are positioned above the diffusion plate. The diffusion plate is disposed above the light source and located at a light mixing distance from the light source. The light mixing distance between the diffusion plate and the light source must be sufficiently long to ensure the luminance uniformity of the backlight when viewing from above the optical films.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an exploded perspective view of a backlight module, in accordance with a first embodiment of this disclosure.

FIG. 2 is a cross-sectional view of the backlight module as shown in FIG. 1.

FIG. 3 is an enlarged cross-sectional view of a circled portion III of FIG. 2.

FIG. 4 is a top-plan view of the backlight module as shown in FIG. 1.

FIG. 5 is an exploded perspective view of a backlight module, in accordance with a second embodiment of this disclosure.

### DETAILED DESCRIPTION

This disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one”.

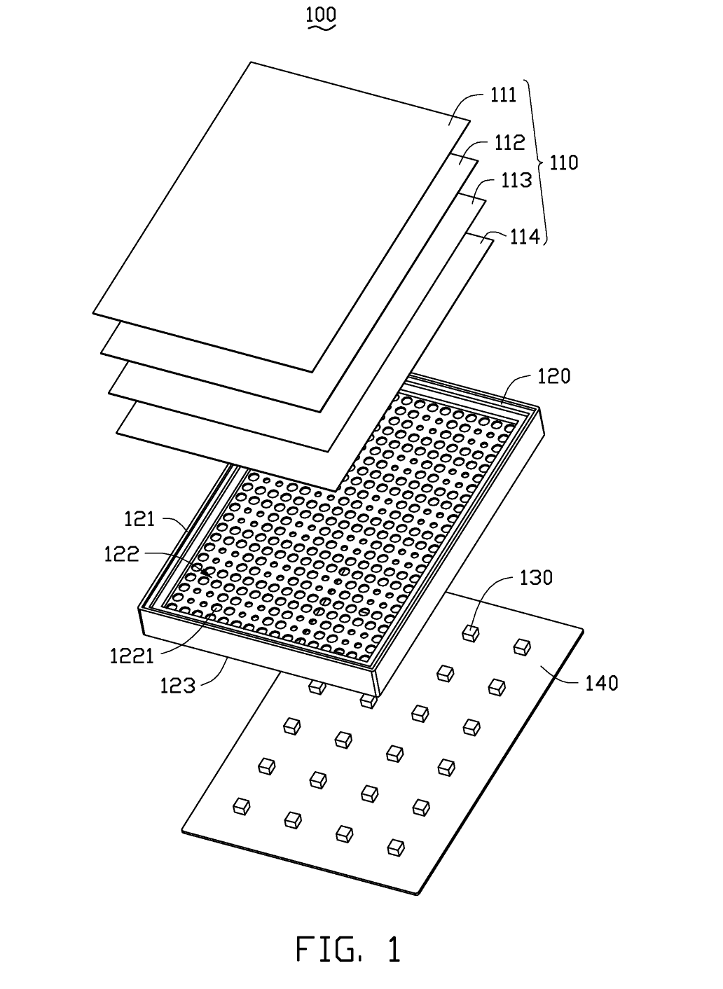

FIG. 1 shows a first embodiment of a backlight module 100. The backlight module 100 can include an optical film 110, a reflective frame 120, a light source panel 140, and a plurality of light sources 130 mounted on the light source panel 140. In the illustrated embodiment, each of the light sources 130 can be a light-emitting diode (LED).

The optical film 110 can include a number of complementary optical elements. In the illustrated embodiment, the complementary optical element can be a first diffusion film 111, a first prism lens 112, a second prism lens 113, and/or a second diffusion film 114.

The reflective frame 120 can be made by integral molding of plastics with high reflectivity, and the reflectivity of the plastics can be 0.9 or more. The reflective frame 120 can include an upper frame 121, a reflective plate 122, and a lower frame 123. The reflective plate 122 can be positioned between the upper frame 121 and the lower frame 123.

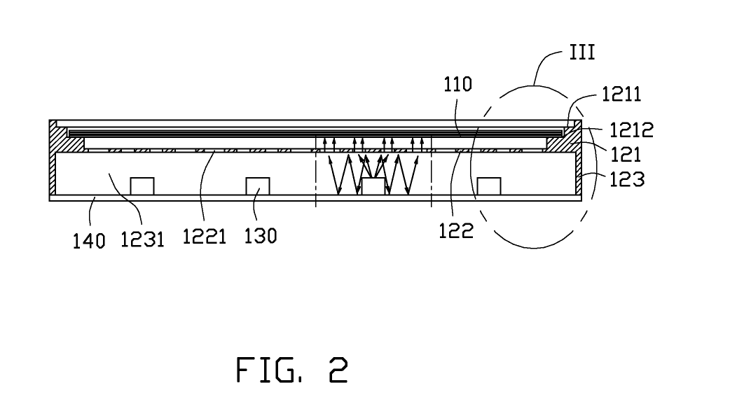

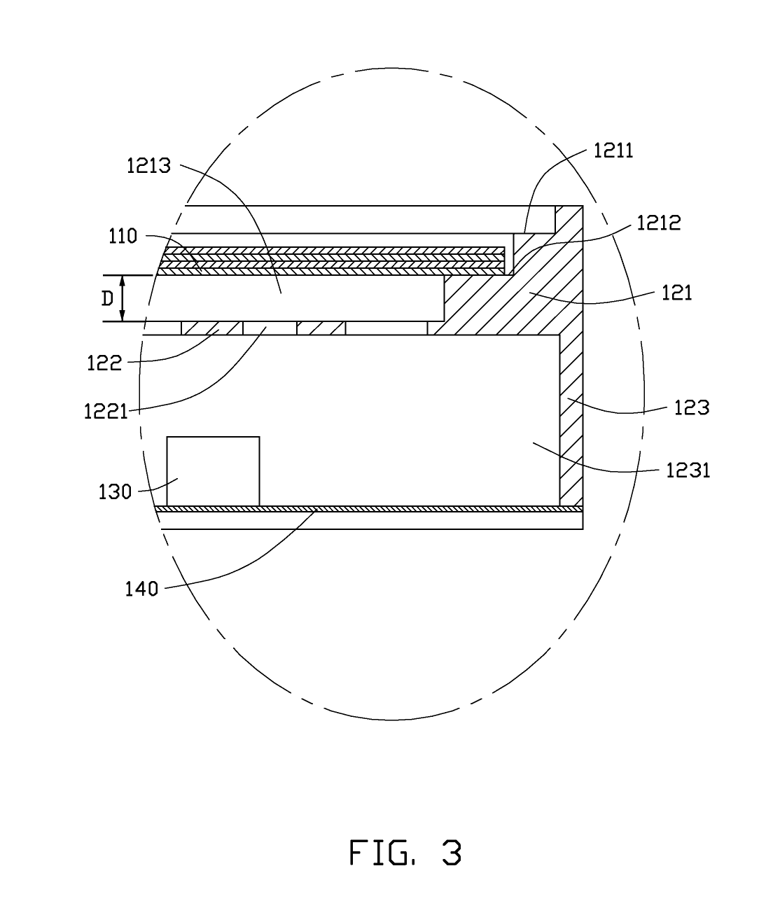

FIG. 2 and FIG. 3 show cross-sectional views of the backlight module 100. The upper frame 121 can be a rectangular frame with an opening toward the optical film 110. The sidewall of the upper frame 121 can define a first receiving portion 1211 configured for receiving the liquid crystal panel (not shown), and a second receiving portion 1212 configured for receiving the optical film 110. The first receiving portion 1211 and the second receiving portion 1212 can be a stepped structure. The liquid crystal panel can be held by a bottom surface and a side surface of the first receiving portion 1211. The optical film 110 can be positioned on the bottom surface of the second receiving portion 1212. The bottom surface of the second receiving portion 1212 can be positioned on the top of the reflective plate 122, thereby the optical film 110 can be disposed above the reflective plate 122 at a mixing light distance D with the reflective plate 122. The optical films 110, the reflective plate 122, and the upper frame 121 of the reflective frame 120 can cooperatively define a mixing light chamber 1213, which can increase the uniformity of the light incident to the optical film 110.

The reflective plate 122 can define a plurality of through holes 1221 configured for transmitting light emitted from the plurality of light sources 130 and light reflected by the light source panel 140 and the reflective plate 122. The through holes 1221 can be circular or rectangular. In other embodiments, the through holes 1221 can be other shapes. The through holes 1221 can be uniformly distributed in an array. A surface toward the light source panel 140 and a surface toward the optical film 110 of the reflective plate 122 can be attached with a high reflection film, and the surfaces of the reflective plate 122 can have high reflectance. In at least one embodiment, the reflectivity of the reflective plate 122 can be 0.9 or more.

To make the luminance of the light emitting from the backlight module 100 uniform, the aperture ratio per unit area of the through holes 1221 can increase as the distance to the light source 130 increases. In the illustrated embodiment, the through holes 1221 can be uniformly distributed and a diameter of each through hole 1221 can increase as the distance to the plurality of light sources 130 increases. In other embodiments, the diameters of through holes 1221 can be same, but the distribution density of the through holes 1221 can increase as the distance to the plurality of light sources 130 increases. As long as the light emitted from the plurality of light sources 130 has uniform luminance and high efficiency to emit from the backlight module 100, the diameters and distribution density of the through holes 1221 can be varied.

The lower frame 123 of the reflective frame 120 can be rectangular with an opening toward the light source panel 140. The inner surface of the lower frame 123 can have high reflectivity, and the reflectivity can be 0.9 or more. In other embodiments, a high reflection film can be adhered to the inner surface of the lower frame 123. The lower frame 123 can connect with the edge of the light source panel 140.

A plurality of light sources 130 can be uniformly mounted in an array on the light source panel 140. The surface of the light source panel 140 toward the reflective plate 122 can have high reflectivity, and in at least one embodiment, the reflectivity can be 0.8 or more. The light source panel 140, the lower frame 123, and the reflective plate 122 cooperatively define a closed chamber 1231. The light emitted from the light sources 130 can be mixed in the closed chamber 1231 and transmitted to the reflective plate 122 through the through holes 1221. As the closed chamber 1231 can mix the light, the closed chamber 1231 can take the place of the light guide plate of the conventional backlight module, and the backlight module 100 can be thin and light, as compared to a conventional backlight module.

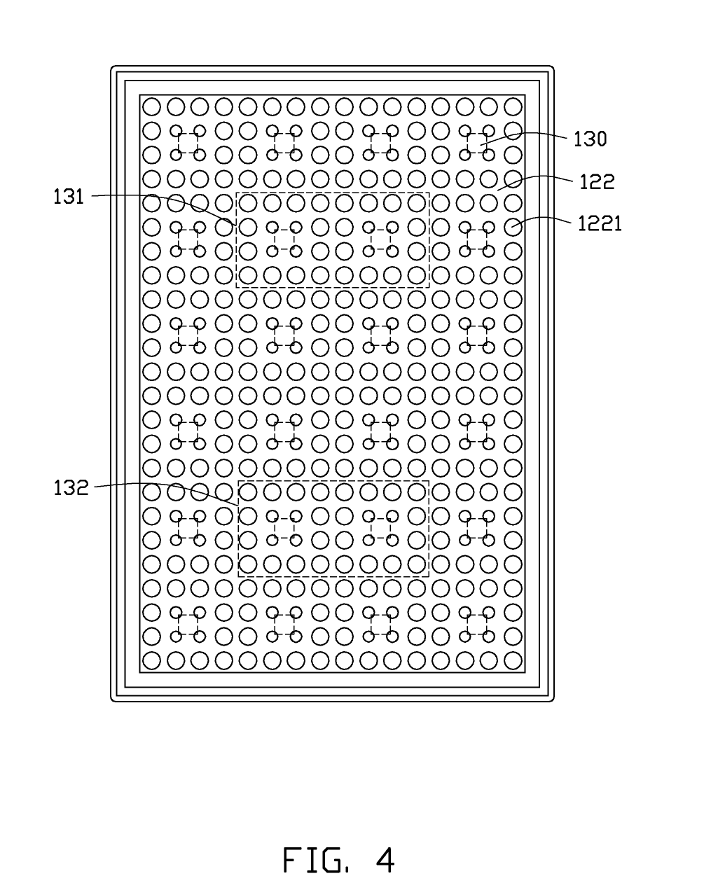

The plurality of light sources 130 can be uniformly distributed, and each light source 130 can be driven by an independent driving circuit. Therefore, the light sources 130 can be controlled independently. FIG. 4 shows that the light sources 130 in areas 131 and 132 are lit, and the LCD panel (not shown) corresponding to the areas 131 and 132 are lit.

In assembly, the first diffusion film 111, the first prism lens 112, the second prism lens 113, and the second diffusion film 114 can be stacked together in order. The optical film 110 can be positioned on the second receiving portion 1212. The lower frame 123 of the reflective frame 120 can be connected with the light source panel 140.

In use, the light sources 130 can emit light. A portion of the light can be transmitted through the through holes 1221. The other portion of the light can be reflected in the closed chamber 1231 repeatedly, and then can be transmitted through the through holes 1221. The light transmitted through the through holes 1211 can be a small beam of light with high density. The light can be mixed in the mixing light chamber 1213, thereby the light incident to the optical films 110 can be more uniform. Because the surface of the light source panel 140, the inner surface of the lower frame 123, and the surfaces of the reflective plate 122 are highly reflective, the availability ration of light is high in the backlight module 100. As the optical films 110 and the reflective plate 122 can define the mixing light distance D, the mixing light distance D can be to equal, or larger than, 0.2 millimeter (mm). The present disclosure can realize both the luminance uniformity of backlight module and thin design of the LCD device.

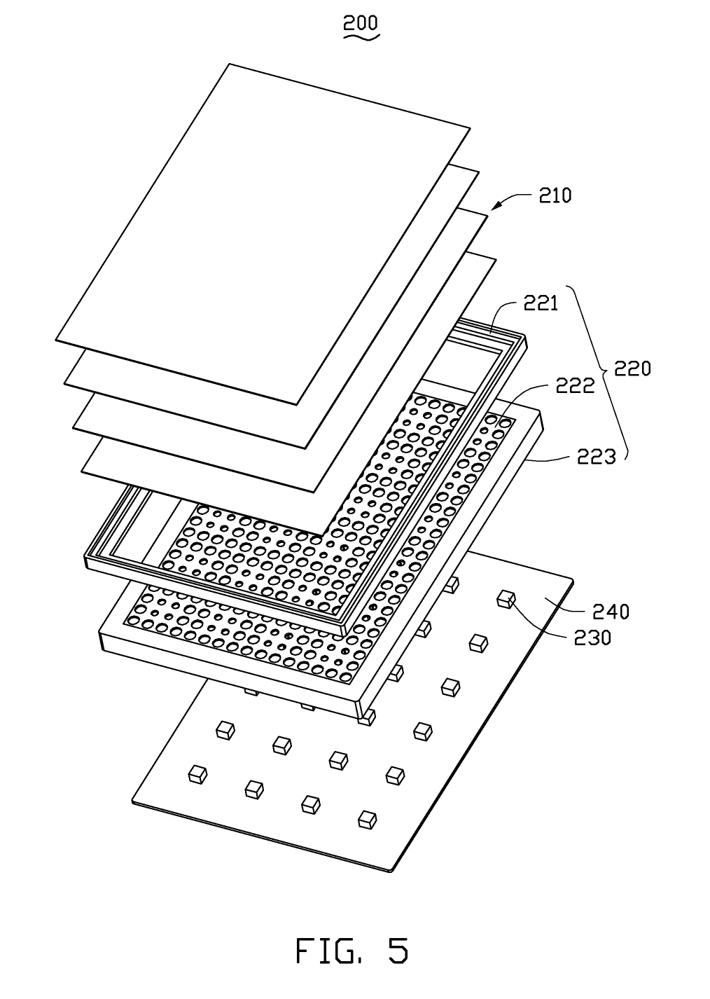

FIG. 5 shows a backlight module 200 in a second embodiment. The backlight module 200 can include an optical film 210, a reflective frame 220, a light source 230, and a lower frame panel 240. The backlight module 200 is the same as the first embodiment, except that an upper frame 221 is made of plastic, a reflective plate 222 and a lower frame 223 can be made by integral molding of highly reflective metal. The reflectivity of the metal can be 0.9 or more. The backlight module 200 can also realize both the luminance uniformity and thin design of LCD device.

The embodiments shown and described above are only examples. Many details are often found in the art such as the other features of a backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A backlight module, comprising:
an optical film;
a light source panel;
a plurality of light sources mounted on the light source panel; and
a reflective frame located between the optical film and the light source panel, the reflective frame comprises:
an upper frame comprising a receiving portion for receiving the optical film;
a lower frame connected with the light source panel; and
a reflective plate positioned between the upper frame and the lower frame, the reflective plate comprises a plurality of through holes; wherein the reflective plate, the lower frame, and the light source panel cooperatively define a closed chamber.

2. The backlight module as claimed in claim 1, wherein the aperture ratio per unit area of the through holes increases as the distance to the light source increases.

3. The backlight module as claimed in claim 2, wherein the through holes are uniformly distributed and a diameter of the through hole increases as the distance to light sources increases.

4. The backlight module as claimed in claim 1, wherein a surface of the light source panel toward the reflective plate has high reflectivity.

5. The backlight module as claimed in claim 1, wherein a light mixing distance between the reflective plate and the optical film is equal to or larger than 0.2 mm.

6. The backlight module as claimed in claim 1, wherein the reflective frame is made of plastic with high reflectivity.

7. The backlight module as claimed in claim 1, wherein the reflective plate and the lower frame are made of metal with high reflectivity.

8. The backlight module as claimed in claim 7, wherein the upper frame is made of plastic.

9. The backlight module as claimed in claim 1, wherein the optical film comprises a first diffusion film, a first prism lens, a second diffusion film, and a second prism lens stacked together.

10. The backlight module as claimed in claim 1, wherein the light source is a light-emitting diode.
